(19) United States
(12) Patent Application Publication
(10) Pub. No.: US 2022/0191703 A1
(43) Pub. Date: Jun. 16, 2022

(54) OPTICAL MULTI-CELL COMMUNICATION SYSTEM WITH EXTENDED COVERAGE

(71) Applicant: SIGNIFY HOLDING B.V., EINDHOVEN (NL)

(72) Inventors: Ruslan Akhmedovich SEPKHANOV, EINDHOVEN (NL); Johan-Paul Marie Gerard LINNARTZ, EINDHOVEN (NL); Michel GERME, CORMELLES LE ROYAL (FR)

(21) Appl. No.: 17/598,367

(22) PCT Filed: Mar. 31, 2020
(86) PCT No.: PCT/EP2020/059035

§ 371 Date: Sep. 27, 2021

(30) Foreign Application Priority Data
Apr. 8, 2019 (EP) 19167832.5

(51) Int. Cl. H04W 16/10; H04B 10/116; H04J 14/08; H04W 16/26

(52) U.S. Cl. CPC H04W 16/10; H04W 16/26; H04J 14/08; H04B 10/116

(57) ABSTRACT

A communication system, method and apparatus that enable combined illumination and communication of data (e.g. LiFi) by achieving extended coverage using just three or more channels. The combined illumination and communication system comprises an arrangement of luminaires as a regular Bravais pattern based on a convex quadrilateral unit cell on the ceiling. Using a spatial reuse pattern of at least three optical color channels, full coverage for the users in that space can be achieved. The predetermined reuse pattern is configured so that a first channel and a second channel are distributed over the Bravais pattern and a third channel is used to cover dead spot areas where the coverage areas of the first and second channels contact each other. Interference can be avoided to achieve full contiguous coverage without requiring the luminaires to synchronize or to communicate with each other.

### FIELD OF THE INVENTION

The invention relates to the field of communication in optical wireless networks, such as—but not limited to—Li-Fi networks, for use in various different applications for home, office, retail, hospitality and industry.

### BACKGROUND OF THE INVENTION

Wireless optical networks, such as Li-Fi networks (named like Wi-Fi networks), enable electronic devices like laptops, tablets, and smartphones to connect wirelessly to the internet. Wi-Fi achieves this using radio frequencies, but Li-Fi achieves this using the light spectrum which can enable unprecedented data transfer speed and bandwidth. Furthermore, it can be used in areas susceptible to electromagnetic interference. It's important to consider that wireless data is required for more than just our traditional connected devices—today televisions, speakers, headphones, printer's, virtual reality (VR) goggles and even refrigerators use wireless data to connect and perform essential communications. Radio frequency technology like Wi-Fi is running out of spectrum to support this digital revolution and Li-Fi can help power the next generation of immersive connectivity.

In visible light communication (VLC) systems, information may be communicated in the form of a signal embedded in the visible light emitted by a light source. VLC may thus also be referred to as “coded light”. The signal may be embedded by modulating a property of the visible light, typically the intensity, according to any of a variety of suitable modulation techniques. For instance, this enables that a sequence of data symbols may be modulated into the light emitted by a light source, such as light emitting diodes (LEDs) and laser diodes (LDs), faster than the persistence of the human eye. VLC merges lighting and data communications in applications such as area lighting, signboards, streetlights, vehicles, and traffic signals. The IEEE 802.15.7 visible-light communication personal area network (VPAN) standard maps the intended applications to four topologies: peer-to-peer, star, broadcast and coordinated. Optical Wireless PAN (OWPAN) is a more generic term than VPAN also allowing invisible light for communication. Contrary to radio frequency (RF) communication, VLC preferably uses a line-of-sight connection between the transmitter and the receiver for best performance.

Based on the modulations, the information in the coded light can be detected using any suitable light sensor. This can be a dedicated photocell (point detector), an array of photo cells possibly with a lens, reflector, diffuser of phosphor converter, or a camera comprising an array of photocells (pixels) and a lens for forming an image on the array. E.g., the light sensor may be a dedicated photocell included in a dongle which plugs into a mobile user device such as a smartphone, tablet or laptop, or the sensor may be the general purpose (visible or infrared light) camera of the mobile user device or an infrared detector initially designed for instance for 3D face recognition. Either way this may enable an application running on the user device to receive data via the light.

VLC is often used to embed a signal in the light emitted by an illumination source such as an everyday luminaire, e.g. room lighting or outdoor lighting, thus allowing use of the illumination from the luminaires as a carrier of information. The light thus comprises both a visible illumination contribution for illuminating a target environment such as a room (typically the primary purpose of the light), and an embedded signal for providing information into the environment (typically considered a secondary function of the light). In such cases, the modulation may typically be performed at a high enough frequency to be beyond human perception, or at least such that any visible temporal light artefacts (e.g. flicker and/or strobe artefacts) are weak enough and at sufficiently high frequencies not to be noticeable or at least to be tolerable to humans. Thus, the embedded signal does not affect the primary illumination function, i.e., so the user only perceives the overall illumination and not the effect of the data being modulated into that illumination.

The paper “Color cell based directional VLC with user mobility”, by Sewaiwar Atul et al, published at the 2016 IEEE International Conference on Communciations Workshops (ICC), discloses the use of color cells (CC) for bidirectional VLC. The proposed CC based communication provides a solution to the issues associated with full coverage and user mobility in a comparatively larger indoor environment. In the CC scheme, a color filter array is utilized at the receiver end and colors in the CC are reused in the CC clusters. The use of CC based communication aims to provide full coverage and user mobility in an efficient manner for bidirectional VLC.

United States patent application US 2011/038638 A1 discloses an apparatus for transmitting VLC data, in which a data processor processes data to be transmitted, a modulator modulates data received from the data processor into a signal for VLC, a light output unit outputs light of a predetermined color and includes in the light a signal of any selected one characteristic among signals of two different characteristics, and a light output controller selects at least one of the signals of different characteristics, and controls the light output unit so that a signal from the modulator is output through the signal of the selected characteristic.

However, in order to function properly the received signal must be strong enough with respect to noise levels and interference levels. A certain minimum signal to noise ratio (SNR) and signal to interference ratio (SIR) must be achieved. For communication at high speed, often Infrared (IR) rather than VLC communication is used, while IR also requires adequate SIR and SNR.

### SUMMARY OF THE INVENTION

It is an object of the present invention to provide an optical multi-cell communication system which avoids interference to achieve enhanced coverage and which does not require luminaires to synchronize or to communicate with each other.

This object is achieved by a system as claimed in claim 1 and a method as claimed in claim 13.

According to a first aspect, a system for wireless optical communication is provided, comprising:

a plurality of luminaires of an illumination system, the plurality of luminaires being arranged for emitting light in at least three channels in the visible and/or invisible range and comprising respective modem units for modulating emitted light with a communication signal to be transmitted and for demodulating detected light to receive a communication signal;

wherein the plurality of luminaires are arranged in a regular (two dimensional) Bravais pattern based on a convex quadrilateral unit cell;

wherein a respective one of the at least three channels is allocated to each communication coverage area of the plurality of luminaires; and

wherein a predetermined reuse pattern of the allocated channels is applied to ensure that different channels are allocated to neighboring coverage areas of the plurality of luminaires wherein:

the predetermined reuse pattern is configured so that a first channel and a second channel are distributed over the Bravais pattern and a third channel is used to cover dead spot areas where the coverage areas of the first and second channels contact each other.

Accordingly, interference among neighboring luminaires can be eliminated or at least reduced to achieve full contiguous coverage without requiring the luminaires to synchronize or to communicate with each other. The communication signal is strong enough with respect to noise levels and interference levels and a certain minimum SNR and SIR can be achieved.

Such a reuse pattern allows to use a third channel at dead spot areas at contact regions of the other coverage areas of the other two channels, so that interference can be substantially reduced. In a more specific example of the fifth option, the predetermined reuse pattern may be configured so that the first and second channels are arranged in a chess board pattern and the third channel is used for dead spot areas at the corners of each central chess board field surrounded by eight neighboring chess board fields. Here chess board pattern is not limited to a pattern of squares, but also regular repeating patterns of other alternating convex quadrilaterals are envisaged.

According to a first option of the first aspect, the plurality of luminaires may be arranged at a ceiling of a building. Thereby, good reception properties can be ensured, since the communication signal is transmitted from above to respective user devices in a communication area.

According to a second option which may be combined with the first option of the first aspect, the at least three channels may correspond to different colors of visible light. This ensures that the channels of neighboring luminaires are sufficiently separated to minimize interference.

Further disclosed is a system for wireless optical communication, comprising: a plurality of luminaires of an illumination system, the plurality of luminaires being arranged for emitting light in at least three channels in the visible and/or invisible range and comprising respective modem units for modulating emitted light with a communication signal to be transmitted and for demodulating detected light to receive a communication signal; wherein the plurality of luminaires are arranged in a regular Bravais pattern based on a convex quadrilateral unit cell; wherein a respective one of the at least three channels is allocated to each communication coverage area of the plurality of luminaires; and wherein a predetermined reuse pattern of the allocated channels is applied to ensure that different channels are allocated to neighboring coverage areas of the plurality of luminaires wherein, the predetermined reuse pattern may be configured so that three channels are successively arranged one after the other in a recurring sequence along each row of the Bravais pattern and are shifted by one or two positions of the recurring sequence in neighbouring rows or lines of the Bravais pattern, so that different channels are allocated to neighboring cells. Such a reuse pattern allows to use a third channel at overlapping areas of the other two channels, so that interference can be substantially reduced.

Further disclosed is a system for wireless optical communication, comprising: a plurality of luminaires of an illumination system, the plurality of luminaires being arranged for emitting light in at least three channels in the visible and/or invisible range and comprising respective modem units for modulating emitted light with a communication signal to be transmitted and for demodulating detected light to receive a communication signal; wherein the plurality of luminaires are arranged in a regular Bravais pattern based on a convex quadrilateral unit cell; wherein a respective one of the at least three channels is allocated to each communication coverage area of the plurality of luminaires; and wherein a predetermined reuse pattern of the allocated channels is applied to ensure that different channels are allocated to neighboring coverage areas of the plurality of luminaires wherein the predetermined reuse pattern may be configured so that two out of four channels are alternately arranged along a row of the Bravais pattern and the other two of the four channels are alternately arranged along a neighbouring row of the rectangular tiling arrangement, so that it is ensured that different channels are allocated to neighboring cells. Such a reuse pattern ensures that no overlapping areas of same channels are generated, so that interference can be prevented.

According to a third option of the first aspect, which can be combined with the first and second option, the first and second channels may be located in an infrared wavelength range and the third channel may be a broader coverage area channel located in the visible range. Thereby, the range of coverage can be increased by the dead spot areas of the broader channel in the visible range.

According to a fourth option of the first aspect, which can be combined with any of the above first to third options, the predetermined reuse pattern may be used for the emitted light of the plurality of luminaires, while a time division multiple access collision resolution in one or more channels may be used for the detected light at the plurality of luminaires. Thereby, uplink processing requirements between user devices and luminaire devices can be reduced.

The Time Division Multiple Access scheme, TDMA, may enable multiple user devices within the coverage area of a luminaire to transmit their uplink traffic to the luminaire one at a time. Preferably such TDMA scheme is coordinated by the luminaire(s); enabling individual user devices to communicate with any one of the luminaires without the need for the user devices to switch to a different transmit wavelength.

Optionally, this mechanism may make use of one of the first, second, or third channel for the uplink traffic to the luminaire, preferably this channel corresponds with the channel used for the downlink traffic by the luminaire, in this manner interference amongst uplink traffic in adjacent cells may be limited.

Alternatively the uplink traffic from the user device may be transmitted on all three channels, in this manner the signal selection is performed at the luminaire, but as this may cause conflicts with uplink traffic in adjacent cells this would need to be taken into account in the TDMA scheme, potentially resulting in a need for luminaires to coordinate with one another.

More alternatively uplink traffic from a user device could make use of a fourth channel dedicated to uplink traffic that avoids the need for the user device to switch channels. The latter is particularly useful when the downlink traffic from the luminaires makes use of visible light, as in such a situation preferably the uplink traffic makes use of invisible light, in this scenario uplink traffic in adjacent cells this would need to be taken into account in the TDMA scheme, potentially resulting in a need for luminaires to coordinate with one another.

According to an fifth option of the first aspect, which can be combined with any of the above first to fourth options, receiver devices for use in coverage areas of the plurality of luminaires may be configured to detect light of all of the at least three channels. Thereby, filter requirements at the luminaire devices can be reduced.

According to a sixth option of the first aspect, which can be combined with any of the first to fifth options, different ones of the at least three channels may be selectable or switchable by at least some of the luminaires based on exchanged control signals or a detection of a channel actively used by a neighboring luminaire, to arrange themselves into a desired reuse pattern, so as to reduce the need for commissioning of the system.

Also disclosed is a system for wireless optical communication, comprising: a plurality of luminaires of an illumination system, the plurality of luminaires being arranged for emitting light in at least three channels in the visible and/or invisible range and comprising respective modem units for modulating emitted light with a communication signal to be transmitted and for demodulating detected light to receive a communication signal; wherein the plurality of luminaires are arranged in a regular (two dimensional) Bravais pattern based on a convex quadrilateral unit cell; wherein a respective one of the at least three channels is allocated to each communication coverage area of the plurality of luminaires; and wherein a predetermined reuse pattern of the allocated channels is applied to ensure that different channels are allocated to neighboring coverage areas of the plurality of luminaires and wherein different ones of the at least three channels may be selectable or switchable by at least some of the luminaires based on exchanged control signals or a detection of a channel actively used by a neighboring luminaire, to arrange themselves into a desired reuse pattern. The above approach would facilitate the commissioning process of the system.

According to a seventh option of the first aspect, which can be combined with any of the above first to sixth options, the system comprises an apparatus for receiving a communication signal modulated on visible and/or invisible light emitted by an illumination system in three different channels, the apparatus comprising:

a plurality of light receivers for selectively detecting light in the at least three channels;

a comparison unit for comparing at least one parameter of the detected light of a first channel and a second channel of the three channels and for generating a selection signal based on the result of comparison; and

a selection unit for selecting one of the at least three channels in response to the selection signal.

The selection of a third channel signal in case of any conflict between the first and second channel signals allows substantial reductions of interference.

According to an eight option of the first aspect, which is an advantageous variant of the seventh option, the comparison unit may be adapted to generate a selection signal for selecting one of the compared first and second channels if the at least one parameter differs at least by a predetermined amount for the two compared channels. Thereby, it can be ensured that a conflict between the signals of the first and second channels can be reliably detected.

According to a ninth option of the first aspect, which is an advantageous variant of the eighth option, the comparison unit may be adapted to generate a selection signal for selecting a third channel of the three channels if the first and second channels cannot be recovered or if the at least one parameter differs by less than the predetermined amount for the compared first and second channels. Thereby, it can be ensured that a conflict between the signals of the first and second channels can be reliably detected and a reliable communication can be guaranteed even if the signals of the first and second channel cannot be recovered.

According to a tenth option of the first aspect, which can be combined with any of the first to ninth options, but in particular with the third option, a system is provided wherein respective ones of the luminaires comprise:

a first luminaire subsystem for emitting communication light modulated by the communication signal;

a second luminaire subsystem for emitting illumination light to be used for illumination;

and are configured to emit the illumination light of the second luminaire subsystem with a wider beam than the modulated communication light of the first luminaire subsystem.

Accordingly, interference between communication signals of neighboring luminaires can be reduced, without suffering from variations of the illumination level.

According to an eleventh option of the first aspect, which is a particularly advantageous version of the tenth option, respective ones of the luminaires may further comprise a light receiver for receiving modulated communication light in all of the three different channels. Thereby, filter requirements at the luminaire device in the uplink direction can be reduced.

Also disclosed is, a user device for receiving a communication signal modulated on visible and/or invisible light is provided, the user device comprising an apparatus for receiving a communication signal modulated on visible and/or invisible light emitted by an illumination system in three different channels, the apparatus comprising: a plurality of light receivers for selectively detecting light in the at least three channels; a comparison unit for comparing at least one parameter of the detected light of a first channel and a second channel of the three channels and for generating a selection signal based on the result of comparison; and a selection unit for selecting one of the at least three channels in response to the selection signal.

According to a second aspect, a method for wireless optical communication is provided, comprising:

emitting light from a plurality of luminaires of an illumination system in at least three channels in the visible and/or invisible range;

modulating the emitted light with a communication signal to be transmitted and demodulating detected light to receive a communication signal;

arranging the plurality of luminaires in a regular Bravais pattern based on a convex quadrilateral unit cell;

allocating a respective one of the at least three channels to each communication coverage area of the plurality of luminaires; and

applying a predetermined reuse pattern of the allocated channels to ensure that different channels are allocated to neighboring coverage areas of the plurality of luminaires

wherein the predetermined reuse pattern is configured so that a first channel and a second channel are distributed over the Bravais pattern and a third channel is used to cover dead spot areas where the coverage areas of the first and second channels contact each other.

Also disclosed is a user device, a method of receiving a communication signal modulated on visible and/or invisible light emitted by an illumination system in three different channels is provided, the method comprising:

selectively detecting light in the at least three channels;

comparing at least one parameter of the detected light of a first channel and a second channel of the three channels;

generating a selection signal based on the result of comparison; and

selecting one of the at least three channels in response to the selection signal.

Also disclosed is a luminaire, a method of transmitting a communication signal modulated on visible and/or invisible light of an illumination system in one of at least three different channels is provided, the method comprising:

emitting communication light modulated by the communication signal;

emitting illumination light to be used for illumination;

using for the illumination light a wider emission beam than for the modulated communication light.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a diagram for illustrating signal strength coverage and interference zones of neighboring luminaires;

FIG. 2 shows schematically an aerial view of an illumination system of luminaires in a quadrilateral pattern with resulting overlapping areas;

FIG. 3 shows schematically an illustration of three cell touchpoints;

FIG. 4 shows schematically a tiling arrangement of three distinct channels of a communication system according to various embodiments;

FIG. 5 shows schematically a tiling arrangement of four distinct channels of a communication system according to various embodiments;

FIG. 6 shows schematically a block diagram of a transceiver device according to various embodiments;

FIG. 7 shows schematically a block diagram of a receiver device according to various embodiments;

FIG. 8 shows a flow diagram of a detection procedure according to various embodiments;

FIG. 9 shows schematically a diagram with exemplary wavelength spectra of light sources and their color channels;

FIG. 10 shows schematically a tiling arrangement of two distinct channels and a third channel for dead spots of a communication system according to various embodiments;

FIG. 11 shows schematically a tiling arrangement of two distinct IR channels and a third VLC channel for dead spots of a communication system according to various embodiments;

FIG. 12 shows a flow diagram of a detection procedure according to various embodiments; and

FIG. 13 shows schematically a block diagram of a receiver device according to various embodiments.

### DETAILED DESCRIPTION OF EMBODIMENTS

Various embodiments of the present invention are now described based on a multi-channel illumination and communication (LiFi) system with a spatial reuse pattern of at least three optical color/wavelength channels.

Throughout the following, a luminaire is to be understood as any type of lighting unit or lighting fixture which comprises one or more light sources (including visible or non-visible (infrared (IR) or ultraviolet (UV)) light sources) for illumination and/or communication purposes and optionally other internal and/or external parts necessary for proper operation of the lighting, e.g., to distribute the light, to position and protect the light sources and ballast (where applicable), and to connect the lamps to the power supply. Luminaires can be of the traditional type, such as a recessed or surface-mounted incandescent, fluorescent or other electric-discharge luminaires. Luminaires can also be of the non-traditional type, such as fiber optics with the light source at one location and the fiber core or “light pipe” at another.

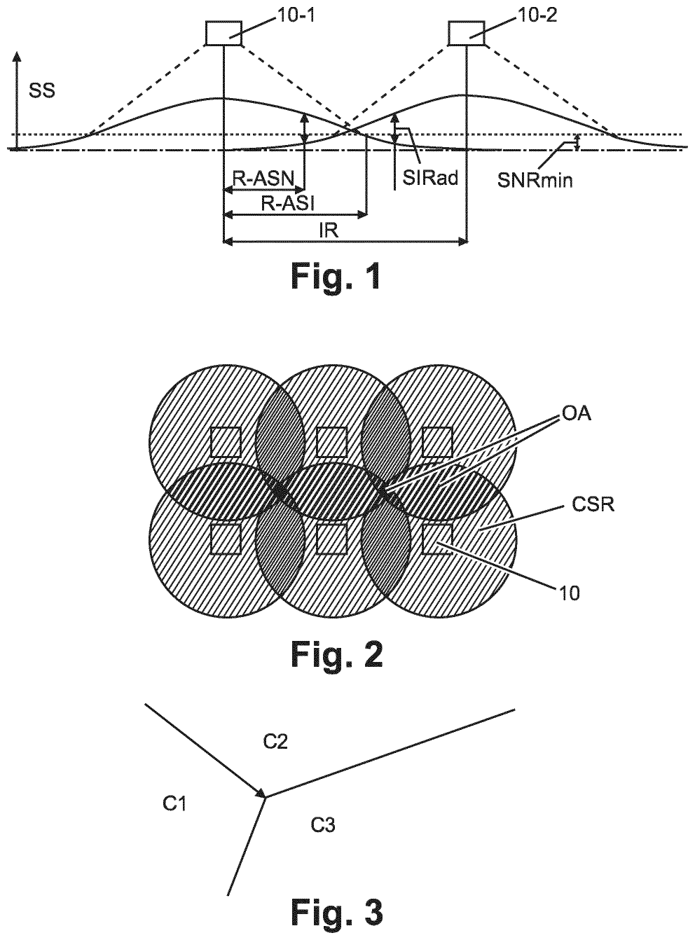

FIG. 1 shows schematically a diagram for illustrating signal strength coverage and interference zones of two neighboring luminaires 10-1, 10-2 which may be fixed e.g. at the ceiling of a building and arranged to distribute light towards the ground floor of the building. More specifically, the diagram of FIG. 1 indicates characteristic curves of a measured signal strength (SS) at or close to the ground floor along the horizontal direction, where the lower dot-dash line indicates an equivalent noise floor.

Typically, in such illumination cases, the light beams from the neighboring luminaires 10-1, 10-2 illuminate a large overlapping zone. This may be desired to achieve uniform light intensities at task areas and to avoid strong shadows from, for instance hands above a table. However, for VLC this means that the signals from multiple light sources interfere. In areas where signals from different luminaires overlap, data transfer of VLC communication is hindered by the interference between different signals of different luminaires.

Therefore, a minimum level of signal-to-noise ratio (SNRₘᵢₙ) with respect to the equivalent noise floor and an adequate signal-to-interference ratio (SIR_{ad}) with respect to the signal strength level of the interfering signal from the respective other neighboring luminaire are indicated in FIG. 1. Based on these values, a distance or range (R-ASN) with adequate SNR with respect to the equivalent noise level and a distance or range (R-ASI) with adequate SIR with respect to the interfering signal from the neighboring luminaire are depicted in FIG. 1. Depending on the beam pattern of the luminaires 10-1 and 10-2, the respective two-dimensional range patterns of the two ranges may be circular, elliptical or any other cross-shape of the radiation beams.

The total distance between the neighboring luminaires 10-1 and 10-2 is indicated as interference range (IR) in FIG. 1.

In the areas where signals from different luminaires overlap, the data transfer is hindered by the interference between different signals of different luminaires, a simplified view of the interference problem is demonstrated in FIG. 2.

FIG. 2 shows schematically an aerial view of an illumination system of luminaires 10 (depicted as squares) arranged in a rectangular grid with resulting overlapping areas OA to illustrate in a simplified way the interference problem. In FIG. 2, a partial area of six luminaires 10 with their circular radiation patterns or communication signal ranges CSR is shown. The overlapping areas OA of the communication signal ranges CSR of neighbouring luminaires 10 indicate areas where data transfer is hindered by the interference.

According to various embodiments, the above interference problem can be overcome or at least mitigated by patterning or tiling three (or more) distinct communication channels and providing robust communication in all areas. More specifically, a combined lighting and optical communication (LiFi) system may comprise multiple luminaires with light emitters where the interference between the light emitters is mitigated or eliminated by choosing different color/wavelength channels for neighboring light emitters, for instance by means of applying a DC-free amplitude modulation in the respective color channels of the white light. A suitable signal scheme (i.e. tiling) is provided for the communication system, e.g., for a rectangular arrangement of the luminaires. Every luminaire may comprise its own modem. The communication system may support at least three channels which may correspond to three different colors/wavelengths and may provide bidirectional high speed, wireless, data communication in a predetermined space and may offer contiguous coverage with an adequate SNR and no interference or at least an adequate SIR between the channels.

According to specific examples explained in more details in the following embodiments, reuse patterns of at least three colors may be used. These reuse patterns may be rectangular reuse patterns (or other shapes). In a specific example, a chessboard pattern may be provided as a basic pattern of two color channels and a third channel may be used to cover the corner points. According to another specific example, the reuse pattern may be used in the downlink direction only (i.e. from luminaire to ground), while a collision resolution without reuse pattern may be used (e.g. for all channels) in the uplink direction. Such a collision resolution or avoidance can be based on at least one of signal processing techniques, scheduling techniques, additional channels, exchanged signal information, specific packet formats, coding techniques etc. to avoid or recover collisions or interferences resulting from jointly received signals of different channels or different sources.

According to a further specific example, different colors or wavelengths may be used for all cells in the downlink direction, while all (ceiling) receivers at the luminaires may be configured to listen to all wavelengths or colors, not only to the wavelength or color used in the downlink direction.

FIG. 3 shows schematically an illustration of three cell touchpoints. In a rectangular or other regular Bravais pattern based on a convex quadrilateral unit cell, there are three cell touchpoints. In such three cell touchpoints, a first cell C1 and a second cell C2 may use different color channels. Yet, in a two-channel system, a remaining third cell C3 must either use the same color channel as the first cell C1 or the same color channel as the second cell C2.

A Bravais lattice or pattern is a type of pattern which when repeated can fill a whole space. In a two-dimensional space such as a floorplan or ceiling of a building, the pattern can be generated by two unit vectors a1 and a2 and two integers k and l so that each point of the pattern, identified by a vector r, can be obtained from: r=k a1+l a2. In two dimensions there are five distinct Bravais patterns, while in three dimensions there are fourteen. The unit cell of the Bravais pattern may comprise any number of luminaires, e.g., four luminaires in a more specific example. The unit cell may be shaped as a convex quadrilateral unit, which is a four-sided figure with interior angles of less than 180 degrees each and both of its diagonals contained within the shape. A diagonal is a line drawn from one angle to an opposite angle, and the two diagonals intersect at one point. The four vertices, or corners, of the convex quadrilateral unit point outward and away from the interior of the shape. Two common types of convex quadrilaterals units are squares and rectangles. The area of an irregular quadrilateral can be determined by finding the area of the four triangles made by the intersecting diagonals. All regular quadrilaterals, which have the same angle for each vertex, are convex.

In any reuse pattern there will be a border of one color channel (e.g. in the first cell C1) being adjacent to another color channel (e.g. in the second cell C2), where a handover must be conducted. This does not cause any problem because on the border between the two cells C1, C2 the two signals can use different color channels and therefore do not interfere.

However, assuming that the color channel of the third cell C3 is the same channel as that of the first cell C1, when reaching the touchpoint C3/C1 from the third cell C3, the signal received from the third cell C3 will be larger than the signal received from the first cell C1 plus the required minimum SIR (e.g. SIR_{ad} in FIG. 1). Otherwise, while arriving from the first cell C1, the signal received from the first cell C1 will be larger than the signal received from the third cell C3 plus the required minimum SIR (e.g. SIR_{ad} in FIG. 1). This situation leads to an interference problem for any SIR>0 dB.

In the following, embodiments for solving the above interference problem are presented in more detail.

According to various embodiments, the above interference problem can be solved by tiling three distinct communication channels. These three channels may be referred to as Red (R), Green (G) and Blue (B). These can be the frequencies or wavelengths that correspond to these colors, but also just any three distinct channels of any visible or invisible wavelength.

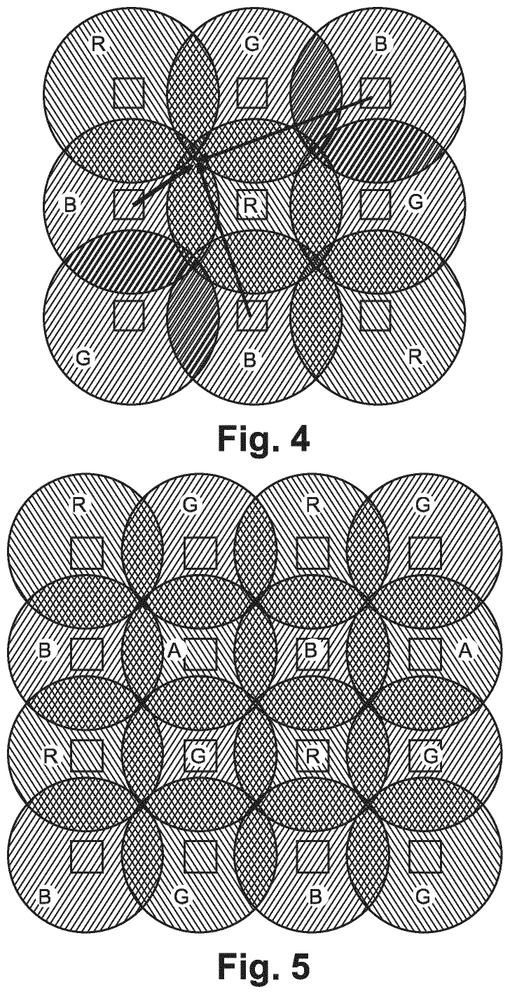

FIG. 4 shows schematically an exemplary rectangular tiling arrangement of the three distinct channels R, G and B of a communication system. The channels R, G and B are successively arranged one after the other in a circular or recurring sequence within one row or line of the rectangular tiling arrangement and are shifted by one or two positions or cells in neighbouring rows or lines of the rectangular tiling arrangement, so that it is ensured that different channels are allocated to neighboring cells. This proposed tiling arrangement of three distinct channels R, G and B prevents interference and thus provides full LiFi coverage. Although there are areas where signals of the same frequency overlap (such areas are right in the middle between four luminaires), there is always another channel that is unique in that area. The system chooses that channel to stay interference-free. Thus, in the interference areas where signals of two identical channels overlap, the system can choose another unique channel, i.e. the remaining third channel.

The luminaires may have a signal radiation pattern (i.e. range or radius of the circular radiation pattern) that limits interference (small arrows in FIG. 4) at wide angle but focusses the signal to achieve coverage (bold arrow in FIG. 4) inside the main circle of the radiation pattern (as shown in FIG. 4) and have a steep roll off (i.e. steep decline) outside this main circle.

Yet it should be noted that for a uniform illumination it may be undesirable to cut the light too sharply at the edge of the main circle of the radiation pattern. This may be achieved by providing luminaires in which unmodulated light (i.e. illumination light) is emitted under higher angles (i.e. wider radiation pattern or beam) and modulated light (i.e. light used for communication) is emitted under lower angles (i.e. smaller radiation pattern or beam).

According to various other embodiments, the above interference problem may also be solved by tiling four distinct communication channels. These four channels may be referred to as Red (R), Green (G), Blue (B) and Amber (A). These can be the frequencies or wavelengths that correspond to these colors, but also just any three distinct channels.

FIG. 5 shows schematically an exemplary tiling arrangement with the four distinct channels R, G, B and A of a communication system. With such a four-channel tiling arrangement e.g. on a rectangular lattice, an interference-free communication and thus full LiFi coverage can be achieved. Here, two (e.g. R and G) of the four channels R, G, B and A are alternately arranged along a row or line of cells of the rectangular lattice and the other two (e.g. B and GR) of the four channels R, G, B and A are alternately arranged along the neighbouring rows or lines of the rectangular lattice, so that it is ensured that different channels are allocated to neighboring cells.

The advantage of this arrangement is that there are no areas where two identical channels (e.g. signal frequencies or wavelengths) overlap.

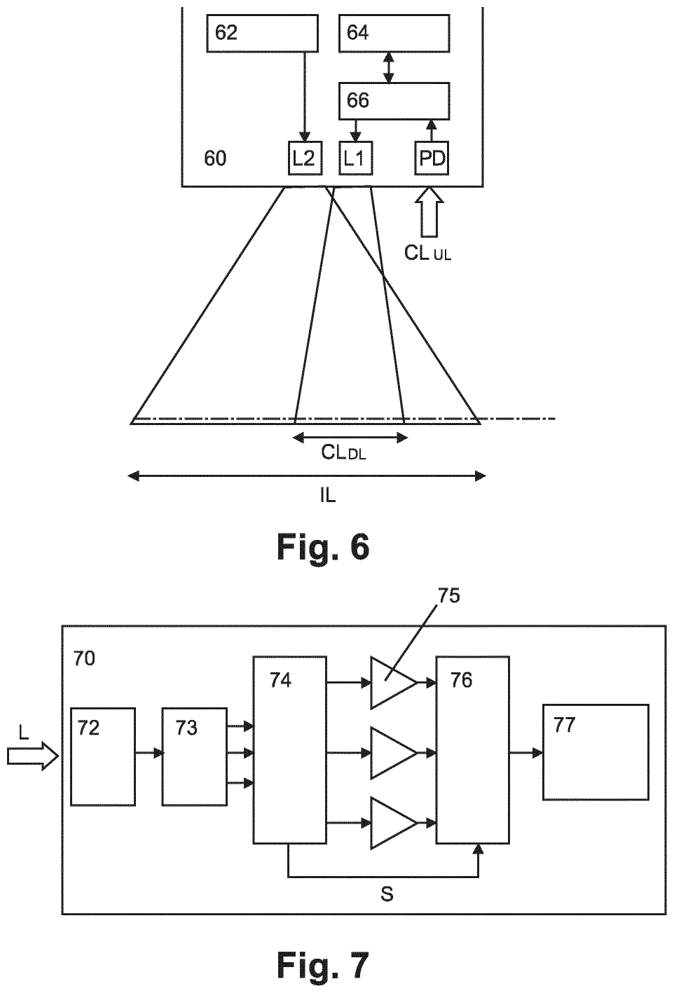

FIG. 6 shows schematically a block diagram of a transceiver device 60 according to various embodiments. It is noted that only those parts of the transceiver are shown which are needed to understand the present invention. Other parts have been omitted for reasons of simplicity.

The transceiver device 60 comprises a first luminaire L1 for emitting Li-Fi-modulated light for communication and a second luminaire L2 for emitting non-modulated light for illumination purposes. The two luminaires L1 and L2 may as well be integrated in a single unit with multiple light elements. The first luminaire L1 is configured to emit Li-Fi-modulated light on a narrower beam CL_{DL} in the downlink direction, while the second luminaire L2 is configured to emit non-modulated illumination light on a wider beam IL. This achieves uniform visible light, while allowing better reuse and less inter-luminaire interference.

Furthermore, the transceiver device 60 comprises a photo detector PD or other light receiving element for receiving Li-Fi-modulated light on any kind of directivity pattern or beam CL_{UL} in the uplink direction. This uplink light signal may be transmitted on all channels, so that the photo detector PD does not require the channel selectivity of the first luminaire L1.

The first luminaire L1 and the photo detector PD may be connected to a modem unit or function 66 which is controlled and supplied by a communication control unit 64, which controls the first luminaire L1 to modulate the communication light and which demodulates the detection signal of the photo detector PD.

Furthermore, the transceiver device comprises an illumination control unit 62 responsible for controlling the second luminaire L2 in accordance with a desired illumination.

FIG. 7 shows schematically a block diagram of a receiver device 70 for a three-channel communication system (e.g. as depicted in FIG. 4) according to various embodiments.

The receiver device 70 may be provided in various types of mobile or fixed user devices for communicating data via the combined illumination and communication system, e.g. a dongle which plugs into a mobile user device such as a smartphone, tablet or laptop, or the like, to enable an application running on the user device to receive data via the light. A received Li-Fi-modulated light signal L is directed via an optical unit (e.g. lens or lens arrangement) 72 to an optical receiver 73 suitable for receiving multiple color channels of the proposed communication system. The optical receiver 73 can be a dedicated photocell (point detector), an array of photo cells possibly with a lens, reflector, diffuser or phosphor converter, or a camera comprising an array of photocells (pixels). The optical receiver 73 is configured to filter out light signals of different channels (i.e. channel signals) of the reuse pattern and to output the filtered light signals at different output terminals.

The three filtered channel signals are compared in a comparison unit 74 and then supplied to respective amplifiers 75. Based on the result of the comparison, the comparison unit 74 generates a selection signal S which is supplied to a selection unit 76 (e.g. a controllable switch or multiplexer or the like), for connecting one output of the three amplifiers 75 to a signal processing unit 77 for demodulating and processing the selected channel signal.

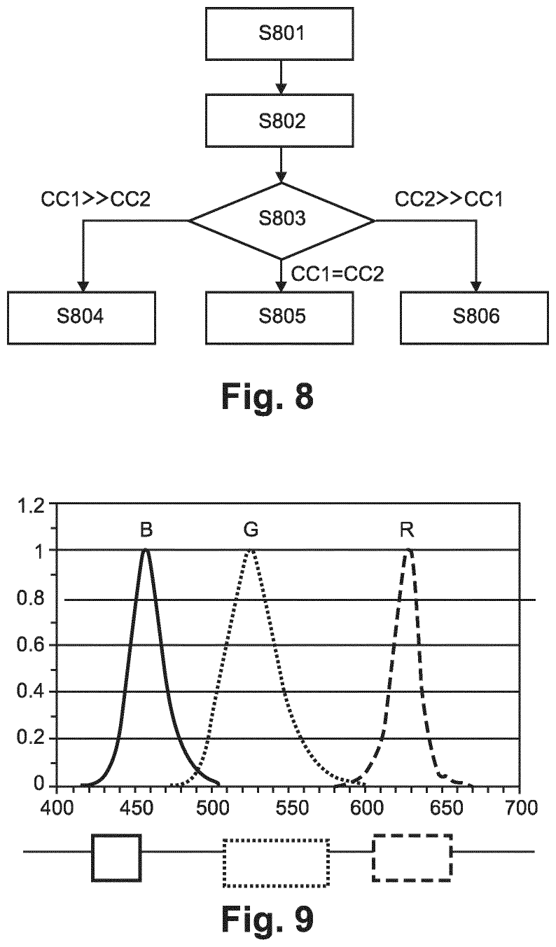

FIG. 8 shows a flow diagram of a detection and selection procedure according to various embodiments. This may be applied in the receiver device of FIG. 7.

In an initial step S801, signals of different channels, e.g. in different sensor areas with different color sensitivity, are detected (e.g. by the optical receiver 73 of FIG. 7). Then, in step S802, an interference cancellation may be applied (e.g. in the comparison unit 74 of FIG. 7). This may be achieved by subtracting detected interference signals of other channels from the respective main channel. In the subsequent step S803, the received signals of the three different color channels are compared (e.g. in the comparison unit 74 of FIG. 7) with respect to at least one predetermined parameter (e.g. signal strength, signal quality, error rate, etc.) and the procedure branches off based on the comparison result.

If it is determined in step S803 that the respective detected channel signals of two predetermined channels CC1 and CC2 (e.g. B and G) are equal or nearly equal (i.e. CC1=CC2) with respect to the at least one predetermined parameter, the procedure continues at step S805 where the selection signal S is generated so as to select the filtered signal of the third channel CC3 (e.g. R), e.g., at the selection unit 76 of FIG. 7. Otherwise, if it is determined in step S803 that the detected channel signal of the first channel CC1 is sufficiently stronger or better than the detected channel signal of the second channel CC2, the procedure continues at step S804 where the selection signal S is generated so as to select the filtered signal of the first channel CC1 (e.g. B), e.g., at the selection unit 76. Otherwise, if it is determined in step S803 that the detected channel signal of the second channel CC2 is sufficiently stronger or better than the detected channel signal of the second channel CC1, the procedure continues at step S806 where the selection signal S is generated so as to select the filtered signal of the second channel CC2 (e.g. G), e.g., at the selection unit 76 of FIG. 7.

The determination as to a sufficient difference between the detected channel signals may be based on a predetermined threshold.

Each channel may contain a strong wanted signal plus interference from a partially overlapping spectrum and/or sensitivity curve, since the color spectra of the channels at the emitter side are partially overlapping and/or the color spectra of the optical receiver 73 (e.g. photo diode(s)) are partially overlapping. Therefore, the receiver device 70 may also be configured to cancel cross-talk in the electrical domain, e.g. in the comparison unit 74 or in the signal processing unit 77.

The optical receiver 73 may pick only a narrow portion of the spectrum, namely the part where only the signal from a single color channel (e.g. LED) is dominant. This may however not provide a good SNR, because frequencies from overlapping spectral regions are discarded.

FIG. 9 shows schematically a diagram of normalized radiometric power (ordinate) vs. wavelength (abscissa) with exemplary wavelength spectra of RGB light sources (e.g. RGB LEDs) and their color channels. Below the abscissa, exemplary sensitivity bands are shown for each color channel. In this example, the color channels are quite narrow with minimal overlap, which is adequate for communication purposes.

If color spectra overlap is larger for better illumination, a filter may be used to avoid interference. Yet this may already discard a portion of each color spectrum, e.g. for blue channel. The problem worsens if the illumination properties require a broader LED spectrum. Then more overlap may need to be introduced.

According to various embodiments, an interference canceller or cancellation function (cf. step S802 in FIG. 8) may be provided to clean up undesired color channel cross-talk. In case of an RGB system, an RGB color sensor having a 3-channel (RGB) photodiode (e.g. an Si photodiode in a surface-mount small plastic package) may be used, which is sensitive to the blue (460 nm), green (540 nm) and red (620 nm) regions of the spectrum and with a spectral response range close to human eye sensitivity. The RGB color sensor may have a 3-segment (RGB) photosensitive area. The interference cancellation may then use the detected color components as a basis for deleting unwanted components.

According to various other embodiments, the interference problem may also be solved by using a basic chess board pattern of two channels, which works everywhere except in corners of the chess board fields where illumination/communication ranges of different luminaires touch. To address this issue, a special measure can be taken to fill in these spots. Namely, a third channel is used for these dead spots. The three channels can be defined by frequencies or wavelengths that correspond to colors but may as well be any three distinct channels.

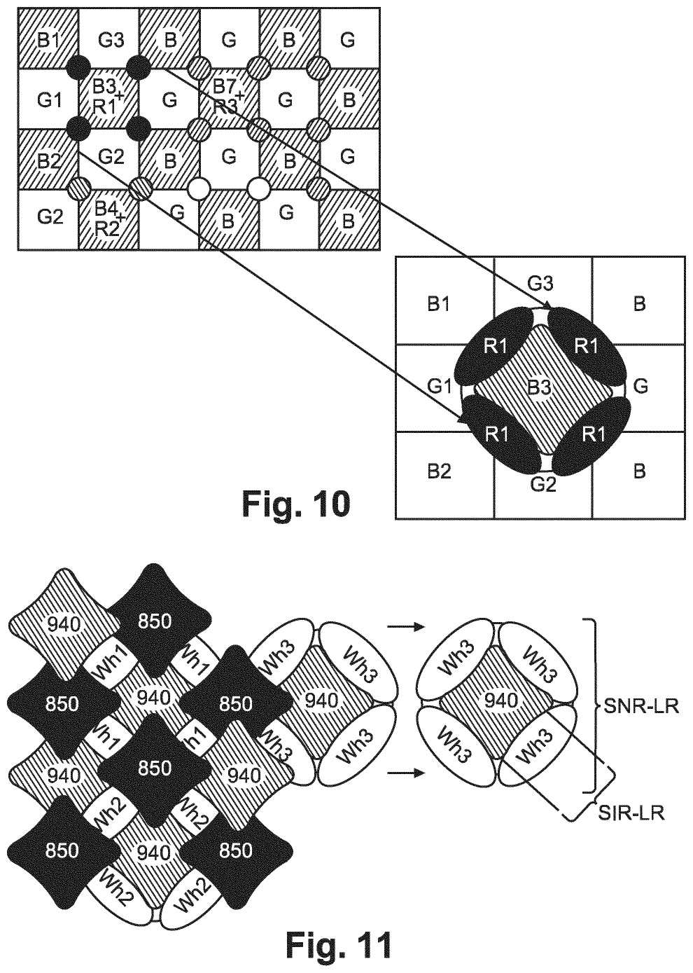

FIG. 10 shows schematically a tiling arrangement of a first example of two distinct channels and a third channel for dead spots of a communication system. Here, the three channels are referred to as Red (R), Green (G) and Blue (B).

In FIG. 10, channels B and G are used for the chess board pattern and a third channel R is used for the dead spots at the corner of a central chess board field surrounded by eight neighboring chess board fields. The partial 9-field area in the left upper corner of the left-hand partial pattern of the tiling arrangement is enlarged in the right-hand portion of FIG. 10, where the emission pattern of a channel B3 of the central field is supported by four dead-sport emission patterns of a channel R1 in the corner regions. Furthermore, as can be gathered from the left-hand pattern of FIG. 10, the chess board fields where the channels designations are marked with a “+” (i.e. B3+, B4+ and B7+) are those fields where the corner dead spots are filled with emission patterns of the third channels designated as R1, R2 and R3. Thus, in the chess board example, one out of four luminaires of at least one (e.g. B) of the two chess board channels may be provided with four additional light sources of the third channel (e.g. R) for dead spot coverage.

Due to the added emission patterns of the extra channel(s) at the dead spots of the chess board pattern, transitions from a good SIR (e.g. SIR>10 dB) for signals from a luminaire of a first channel to a good SIR (e.g. SIR>10 dB) for signals from a luminaire of a neighboring second channel can be ensured.

It is noted that the above interference prevention principle can be applied to other patterns of two alternating channels with other field shapes as well, where identified dead spot areas are covered by an emission pattern of a third channel.

FIG. 11 shows schematically a tiling arrangement of another example with two distinct IR channels and a third VLC channel for the dead spots of a communication system according to various embodiments.

More specifically, spectral areas around 850 nm and 940 nm may be used for the two IR channels of the chess board pattern, while one of every four luminaires of the 940 nm IR channel uses a visible white color spectrum for broader coverage of the third VLC channel for the dead spots at the corners. Thus, three types of setting and/or three types of luminaires are used in this example, e.g., 850 nm (IR) luminaires, 940 nm (IR) luminaires, and enhanced 940 nm (IR) luminaires with an extra VLC support channel (e.g. white or blue channel) for dead sport coverage. All luminaires contain one IR transmitter. The modulation of the white channel may be identical to the 940 nm IR channel, while every cell or field of the chess board pattern may have its own modem.

Similar to FIG. 10, a partial area of the pattern on the left-hand side of FIG. 11 is shown on the right-hand side of FIG. 11. As can be gathered from the right-hand side pattern of FIG. 11, the limited range (SNR-LR) for sufficient SNR for the VLC communication can be enhanced by the broader coverage of the white VLC channel at the dead spots, while the limited range (SIR-LR) for adequate SIR for the IR communication is smaller.

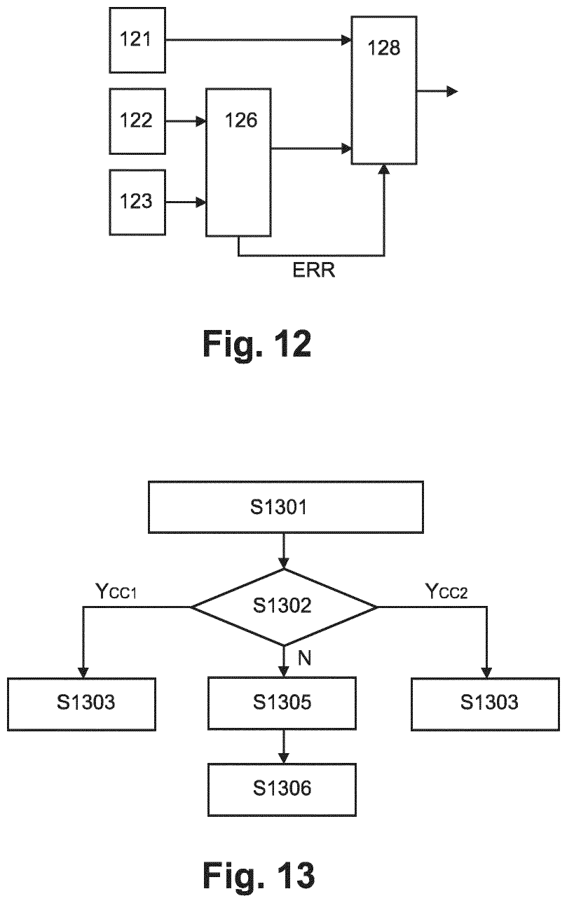

FIG. 12 shows schematically a block diagram of a front end stage of a receiver device according to various embodiments, which could be used in the examples of FIGS. 10 and 11. The receiver device may be provided in various types of mobile or fixed user devices for communicating data via the combined illumination and communication system, e.g. a dongle which plugs into a mobile user device such as a smartphone, tablet or laptop, or the like, to enable an application running on the user device to receive data via the light.

The receiver device comprises three photo detectors 121 to 123 (e.g. photo diodes) of which two photo detectors 122 and 123 (e.g. sensitive to two IR ranges 850 nm and 940 nm in the example of FIG. 11 or to two VLC ranges of blue and green color in the example of FIG. 10) are used for the emission patterns of the chess board fields and the third photo detector 121 (e.g. sensitive to a VLC ranges of white color in the example of FIG. 11 or to a VLC range of red color in the example of FIG. 10) is used for the dead spot emission patterns.

A decision unit 126 may be configured as an integrated circuit with two inputs (e.g. multiple-input-multiple-output (MIMO) inputs) to which the two photo detectors 122 and 123 are connected. The decision unit 126 generates a failure message ERR if it cannot recover an output signal of the photo detectors 122 and 123. If an additional selection unit 128 of the front-end stage, to which the failure signal ERR is supplied, detects the failure signal ERR, it switches to the remaining output of the third photo detector 121 for the dead spot emission patterns.

FIG. 13 shows a flow diagram of a detection procedure according to various embodiments, which could be used in the examples of FIGS. 10 and 11.

In an initial step S1301, the signals of the two different channels CC1, CC2 of the chess board fields (e.g. B and G or 850 nm and 940 nm) are detected (e.g. by the decision unit 126 of FIG. 12). Optionally, an interference cancellation may be applied, e.g., by subtracting detected interference signals of other channels from the respective main channel. In the next step S1302, the received signals of the two different channels CC1, CC2 of the chess board fields are compared (e.g. in the decision unit 126 of FIG. 12) with respect to at least one predetermined parameter (e.g. signal strength, signal quality, error rate, etc.) and the procedure branches off based on the comparison result.

If it is determined in step S1302 that none of the respective detected channel signals of two channels CC1 and CC2 (e.g. B and G or 850 nm and 940 nm) can be recovered, the procedure continues at step S1305 where the failure signal ERR is generated. Then, in step S1306 the third channel signal (e.g. R or White) of the dead spot emission patterns is selected (e.g. by the switching unit 128 of FIG. 12) for further processing. Otherwise, if it is determined in step S1302 that the detected channel signal of the first channel CC1 is sufficiently stronger or better than the detected channel signal of the second channel CC2, the procedure continues at step S1303 and the filtered signal of the first channel CC1 (e.g. B or 850 nm) is selected (e.g. by the decision unit 126 of FIG. 12) and forwarded for further processing. Otherwise, if it is determined in step S1302 that the detected channel signal of the second channel CC2 is sufficiently stronger or better than the detected channel signal of the second channel CC1, the procedure continues at step S1304 where the channel signal of the second channel CC2 (e.g. G or 940 nm) is selected (e.g. by the decision unit 126 of FIG. 12) and forwarded for further processing.

The determination as to a sufficient difference between the detected channel signals may be based on a predetermined threshold.

According to various other embodiments, any regular Bravais pattern based on a convex quadrilateral unit cell (such as a non-rectangular quadrilateral pattern, a parallelogram pattern, a hexagonal pattern, a triangular pattern or other types of multi-angular patterns) may be used for arranging the luminaires e.g. at the ceiling of a building. The cell forms of the regular pattern may correspond to standard luminaire layouts (e.g. square or rectangular or parallelogram layouts). As an example, non-rectangular patterns may be almost rectangular, but where each row of luminaires would be shifted by some small distance (e.g. smaller than the lattice spacing). This leads to patterns where the unit cell is not a rectangle, but a parallelogram or the like. As a further example, two lines of T-LED-style luminaires may be provided in an office room, where the orientation of the luminaire can be the same or opposite. In case of an opposite orientation, a parallelogram pattern may be obtained. Although network communication devices may be part of a luminaire, they may also be retrofit network equipment integrated with a luminaire, e.g., as an add-on unit for an upgradeable luminaire.

According to various embodiments, the emitters of the luminaires may be mounted, e.g. on a ceiling of a building, along parallel lines (which is the standard configuration for linear lighting arrangements). Additionally or alternatively, the smallest angle within the convex quadrilateral may be at least above 45 degrees, or more preferably above 60 degrees, so that a more “squarish” pattern is obtained, which is advantageous as the unit cell then more easily matches the footprint of an emitter.

According to various other embodiments, luminaire devices with adjustable or selectable luminaires may be used in all above embodiments, so that different channels can be selected or that it can be switched between the channels to provide for different pattern arrangements during installation. Or, the luminaire may be configured to control each other (e.g. via control signals or beacons or the like or without interaction by detecting what channel the neighboring luminaire is actively using) to arrange themselves into a desired reuse pattern (e.g. check board pattern).

To summarize, a communication system, method and apparatus that enable combined illumination and communication of data (e.g. Li-Fi) by achieving extended coverage using just three or more channels have been described. The combined illumination and communication system may comprise an arrangement of luminaires as a regular Bravais pattern based on a convex quadrilateral unit cell on the ceiling. Using a spatial reuse pattern of at least three optical color channels, full coverage for the users in that space can be achieved. Interference can be avoided to achieve full contiguous coverage without requiring the luminaires to synchronize or to communicate with each other.

While the invention has been illustrated and described in detail in the drawings and foregoing description, such illustration and description are to be considered illustrative or exemplary and not restrictive. The invention is not limited to the disclosed embodiments. The proposed detection and/or selection procedures can be applied to and possibly standardized in other types of wireless networks and with other types cells and/or reuse patterns.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage. The described operations like those indicated in FIGS. 8 and 13 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A system for wireless optical communication, comprising:
a plurality of luminaires of an illumination system;
the plurality of luminaires being arranged for emitting light in at least three channels in the visible and/or invisible range and comprising respective modem units for modulating emitted light with a communication signal to be transmitted and for demodulating detected light to receive a communication signal;
wherein the plurality of luminaires are arranged in a regular Bravais pattern based on a convex quadrilateral unit cell;
wherein a respective one of the at least three channels is allocated to each communication coverage area of the plurality of luminaires;
wherein a predetermined reuse pattern of the allocated channels is applied to ensure that different channels are allocated to neighboring coverage areas of the plurality of luminaires; and
wherein the predetermined reuse pattern is configured so that a first channel and a second channel are distributed over the Bravais pattern and a third channel is used to cover dead spot areas where the coverage areas of the first and second channels contact each other.

2. The system of claim 1, wherein the plurality of luminaires are arranged at a ceiling of a building.

3. The system of claim 1, wherein the at least three channels correspond to different colors of visible light, different wavelengths of invisible light, or a mixture of both.

4. The system of claim 1, wherein the first and second channels may be located in an infrared wavelength range and the third channel may be a broader coverage area channel located in the visible range.

5. The system of claim 1, wherein the predetermined reuse pattern is used for the emitted light of the plurality of luminaires while time division multiple access collision resolution scheme is used for the detected light at the plurality of luminaires.

6. The system of claim 1, wherein receiver devices for use in coverage areas of the plurality of luminaires are configured to detect light of all of the at least three channels.

7. The system of claim 1, wherein different ones of the at least three channels are selectable or switchable by at least some of the luminaires based on exchanged control signals or a detection of a channel actively used by a neighboring luminaire, to arrange themselves into a desired reuse pattern.

8. The system of claim 1, comprising an apparatus for receiving a communication signal modulated on visible and/or invisible light emitted by an illumination system in three different channels, the apparatus comprising:
a plurality of light receivers for selectively detecting light in the at least three channels;
a comparison unit for comparing at least one parameter of the detected light of the first channel and the second channel of the three channels and for generating a selection signal based on the result of comparison; and
a selection unit for selecting one of the at least three channels in response to the selection signal.

9. The system of claim 8, wherein the comparison unit is adapted to generate a selection signal for selecting one of the compared first and second channels if the at least one parameter differs at least by a predetermined amount for the two compared channels.

10. The system of claim 9, wherein the comparison unit is adapted to generate a selection signal for selecting a third channel of the three channels if the first and second channels cannot be recovered or if the at least one parameter differs by less than the predetermined amount for the compared first and second channels.

11. The system of claim 1, wherein respective ones of the luminaires comprise:
a first luminaire subsystem for emitting communication light modulated by the communication signal;
a second luminaire subsystem for emitting illumination light to be used for illumination; and
wherein the respective ones of the luminaires are configured to emit the illumination light of the second luminaire subsystem with a wider beam than the modulated communication light of the first luminaire subsystem.

12. The system of claim 11, wherein the respective ones of the luminaires further comprise a light receiver for receiving modulated communication light in all of the three different channels.

13. A method for wireless optical communication, comprising:
emitting light from a plurality of luminaires of an illumination system in at least three channels in the visible and/or invisible range;
modulating the emitted light with a communication signal to be transmitted and demodulating detected light to receive a communication signal;
arranging the plurality of luminaires in a regular Bravais pattern based on a convex quadrilateral unit cell;
allocating a respective one of the at least three channels to each communication coverage area of the plurality of luminaires; and
applying a predetermined reuse pattern of the allocated channels to ensure that different channels are allocated to neighboring coverage areas of the plurality of luminaires;
wherein the predetermined reuse pattern is configured so that a first channel and a second channel are distributed over the Bravais pattern and a third channel is used to cover dead spot areas where the coverage areas of the first and second channels contact each other.
